(19) United States
(12) Patent Application Publication
(10) Pub. No.: US 2008/0270444 A1
(43) Pub. Date: Oct. 30, 2008

(54) SYSTEM, METHOD AND TOOL FOR WEB-BASED INTERACTIVE GRAPHICAL VISUALIZATION AND AUTHORING OF RELATIONSHIPS

(75) Inventors: Mark A. Brodie, Briarcliff, NY (US); Jonathan Lenchner, North Salem, NY (US); Chang-Shing Perng, Bedford Hills, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/739,176

(22) Filed: Apr. 24, 2007

(51) Int. Cl. G06F 17/30

(52) U.S. Cl. 707/102

(57) ABSTRACT

A graphical user interface for allowing an end-user to navigate and edit a hierarchy of objects and relationships is disclosed. The user can add or remove patent and children data objects to or from the view by clicking on a given node, allowing the hierarchy to be examined to any desired level of detail. The user can drag-and-drop nodes from a palette to add new nodes to the database. Similarly, the user can add new relationships by drawings a link between two nodes in the view. The user can delete objects or relationships by clicking on them. The user can modify objects or relationships by clicking on them and changing their properties. The graphical user interface automatically scales and re-adjusts to accommodate the modified object relationships.

### TRADEMARKS

IBM® is a registered trademark of International Business Machines Corporation, Armonk, N.Y., U.S.A. Other names used herein may be registered trademarks, trademarks or product names of International Business Machines Corporation or their companies.

### BACKGROUND

1. Technical Field

This invention relates generally to a graphical user interface and particularly to graphically editing and viewing hierarchical relationships.

2. Description of Background

Hierarchies in a graphical user interface (GUI) are often portrayed using textual models (e.g., in a directory listing or via a tree view). Graphical tools ordinarily handle general process flow and do not have support for hierarchical navigation. Current systems fail to address the problem of graphically editing and viewing hierarchical relationships in a GUI. Further, current systems fail to provide a means to navigate up and down a hierarchy, seeing which objects are parents or children of other objects, at any desired level. Current systems also fail to provide a means to modify existing hierarchies by inserting new objects and relationships, and deleting or changing existing objects and relationships. Therefore, there is a need for an intuitive and natural graphical user interface for viewing and editing the objects and relationships.

### SUMMARY

According to an exemplary embodiment, a method is provided for displaying and editing a hierarchy of object relationships. The method includes storing in a computer file space a plurality of data objects. The method identifies hierarchical relationships among the plurality of interrelated data objects, such that some objects may be dynamically defined as parent objects, which may each have at least one dynamically defined child data object. The method also includes assembling a plurality of parent data objects and a plurality of child data objects in a repository. The method provides a graphical user interface view pane for arranging one or more of the parent data objects and child data objects in a nodal tree-view, wherein any parent or child data object can be added or removed from view. The method allows the data objects to be modified by a process wherein a palette is provided that contains a collection of object and relationship types, from which new nodes and links can be added to the view pane in a drag and drop process. Further, a prosperities pane is provided for displaying the properties of at least one of a selected object, node and link. The method allows the user to navigate the hierarchy through parent data objects for displaying hierarchical relationships between parent objects and child objects and it also allows the user to navigate up the hierarchy through child objects for displaying and editing hierarchical relationships between parent objects and child objects. Selecting, dragging, dropping and linking objects shown in the view pane and selected from the palette can modify existing object relationships. Finally, the graphical user interface scales and re-adjusts the display in accordance with the user-modified objects relationships.

System and computer program products corresponding to the above-summarized method is also described and claimed herein.

Additional features and advantages are realized through the techniques of the exemplary embodiments described herein. Other embodiments and aspects are described in detail herein. For a better understanding of the exemplary embodiments of the invention with advantages and features, refer to the description and to the drawings.

### BRIEF DESCRIPTION OF THE DRAWINGS

The subject mater, which is regarded as an exemplary embodiment of the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a GUI displaying objects in a database in accordance with an exemplary embodiment.

FIG. 2A illustrates a GUI having child objects for navigating down a hierarchy in accordance with the exemplary embodiments.

FIG. 2B illustrates a GUI having parent objects for navigating up a hierarchy in accordance with the exemplary embodiments.

FIG. 2C illustrates a GUI for removing objects from the view in accordance with the exemplary embodiments.

FIG. 3A illustrates a GUI for adding objects to the database in accordance with the exemplary embodiments.

FIG. 3B illustrates a GUI for modifying objects in the database in accordance with the exemplary embodiments.

FIG. 3C illustrates a GUI for modifying relationships in the database in accordance with the exemplary embodiments.

The detailed description explains exemplary embodiments, together with advantages and features, by way of example with reference to the drawings.

### DETAILED DESCRIPTION

The embodiments disclosed herein describe a graphical user interface, which allows an end-user to navigate and edit a hierarchy of objects and relationships. The user can add or remove parent and children nodes to or from the view by simply clicking on a given node, allowing the hierarchy to be examined to any desired level of detail. The user can drag-and-drop nodes from a palette to add new nodes to the database. Similarly, the user can add new relationships by establishing a link between two nodes in the view. The user can delete objects or relationships by clicking on them. The user can modify object or relationships by clicking on them and changing their properties. The graphical user interface automatically scales and re-adjusts to accommodate the modified object relationships.

The embodiments disclosed herein address the problem of graphically editing and viewing hierarchical relationships. One embodiment disclosed herein is a lightweight, web-launchable application, which provides interactive visualization and editing of hierarchical relationships. The exemplary embodiments allow a user to see generations of parents and children of a given object in the hierarchy. The user controls the degree of expansion and contraction of each level/object. The GUI adjusts and resizes according to the degree of expansion and contraction. Given a database of objects and dependency relationships between them, it is important to provide an intuitive and natural graphical user interface for viewing and editing the objects and relationships. The exemplary embodiments allow a user to navigate and modify complex relationships between objects.

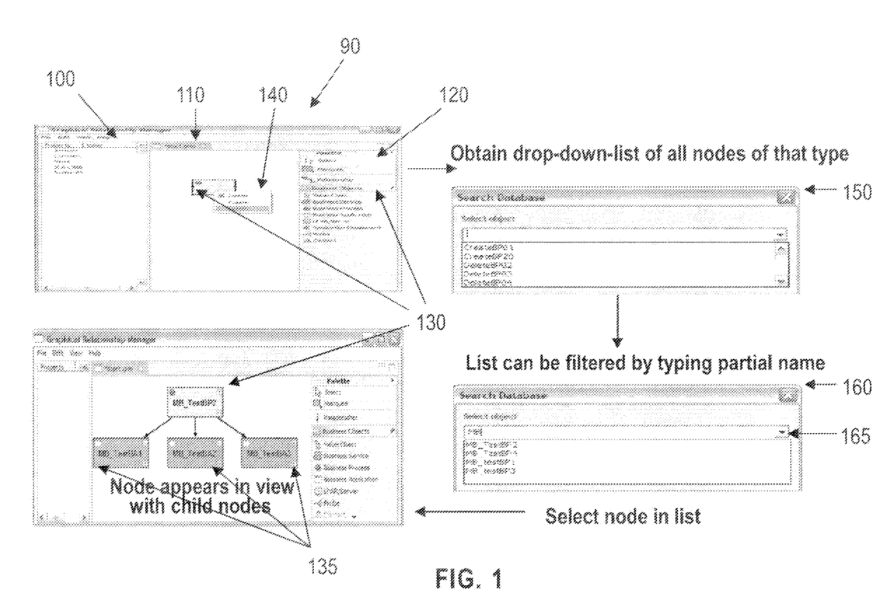

Turning now to the drawings in greater detail, it will be seen that FIG. 1 shows the overall appearance of the hierarchical graphical user interface (GUI) 90. In an exemplary embodiment, there are three panes: the Properties pane 100 on the left shows properties of the currently selected node or link; the View pane 110 in the middle shows the part of the hierarchy currently in the view; and Palette 120 on the right shows the collection of object and relationship types, where new nodes and links can be added to the view using a drag-and-drop process. Each of the panes is resizable and scrollable.

FIG. 1 shows how to view an object in the database. The user drags the object type 130 from the palette 120 into the view 110, clicks on the selected node to bring up the menu 140, which has a drop down options list 150. The user selects “Search” in the options list, which displays a list 160 of all objects of that type. The user can select an object from the list 160, or if the list is long, he can type a partial name in the box provided 165 and the list 160 will show only those objects matching the partial name. Once the user selects an object, the object 130 is added to the view 110, together with all its child nodes 135.

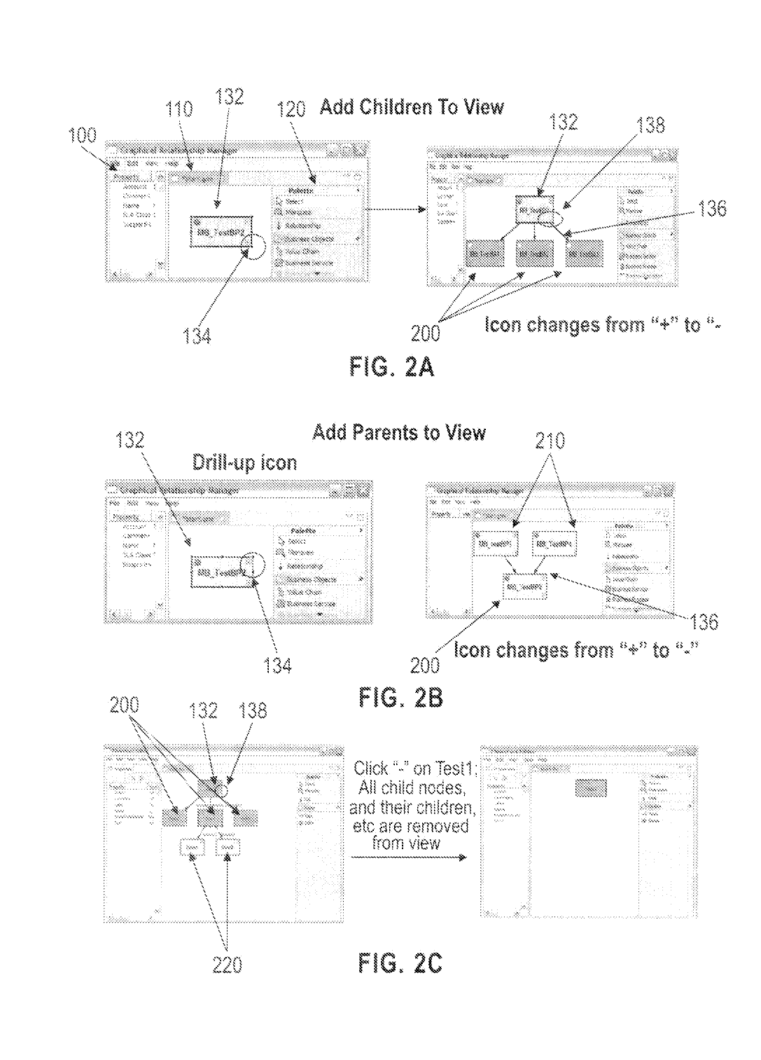

In an exemplary embodiment, FIG. 2A shows how to navigate down the hierarchy (“drill down”). The user clicks on the “+” icon 134 at the bottom of any (selected) node 132. The “+” icon 134 indicates which nodes have child nodes 200 which are not currently shown in the view. The child nodes 200 are then added to the view with links (arrows) 136 from the parent node 132 to them. The “+” icon 134 changes to a “−” icon 138, indicating that all the child nodes 200 are shown in the view.

In an exemplary embodiment, FIG. 2B shows how to navigate up the hierarchy (“drill up”). The user clicks on the “+” icon 134 at the top of any (selected) node 132. The “+” icon 134 indicates which nodes have parent nodes 132 which are not currently shown in the view. The parent nodes 132 are then added to the view with links (arrows) 136 from them to the child node 200. The “+” icon 134 changes to a “−” icon, indicating that all the parents nodes 210 are shown in the view.

In an exemplary embodiment, as objects and nodes are added and removed from the View pane 110, the hierarchical GUI 90 automatically adjusts and resizes the window. Therefore, the window can grow and contract as the need arises. However, the view may become too crowded. FIG. 2C shows how to prevent the view from becoming filled with too many nodes by hiding nodes that are currently in the view. Clicking on the “−” icon 138 at the bottom of a (selected) node 132 causes all the child nodes 200, and all their child nodes 220, and so on, to be removed from the view. Similarly, clicking on the “−” icon 138 at the top of a node causes all the parent nodes 210, and all their parent nodes, and so on, to be removed from the view.

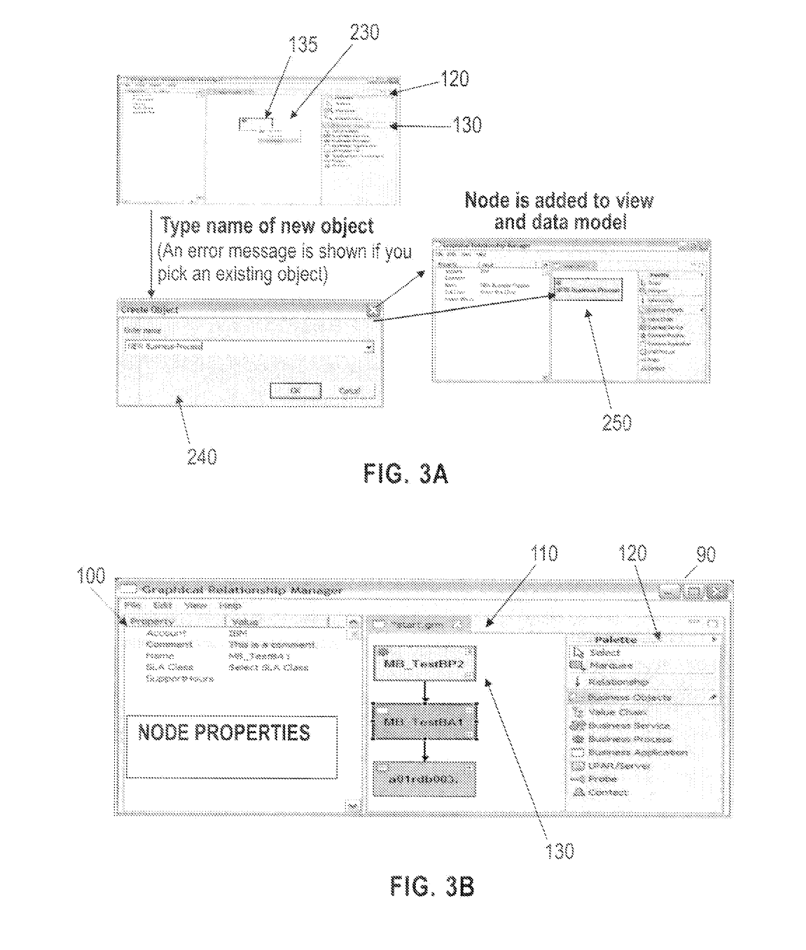

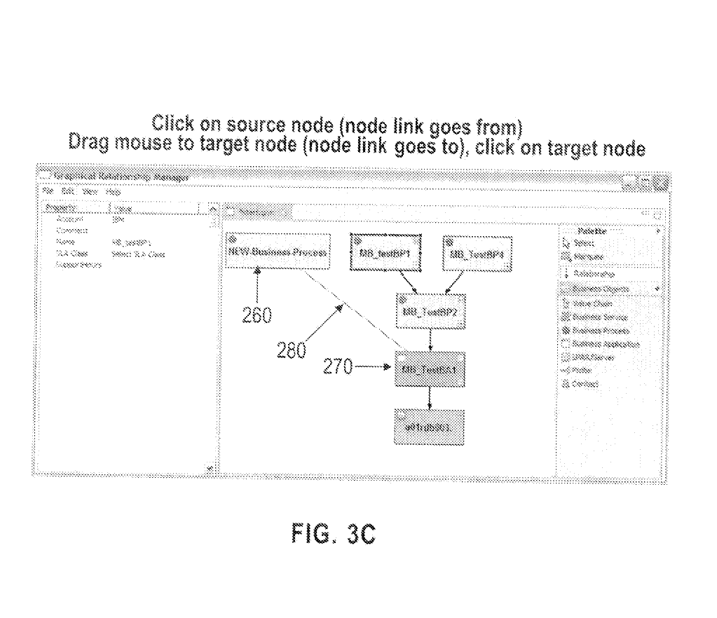

In an exemplary embodiment, FIG. 3A shows how to add a new object 135 to the database. The user drags the object type 130 from the palette 120 into the view, clicks on the object 135 to bring up the menu 230, and selects “Create”. The user must choose a name for the new object—this name must be different from the existing objects. To facilitate this process, the user sees a list of all objects of that type and can type a partial name in the box 240 provided and the list shows only those objects matching the partial name. This process allows the user to find a unique name for the new object. (If the user selects a name that already exists, an error message is shown.) Once the user has selected the name, the new object 250 is added to the view.

In an exemplary embodiment, FIG. 3B shows how to modify the properties of an object 130. The user clicks on the object 130, and the object's properties and their values are shown in the left-hand pane 100. The user can click on any of the editable properties and modify its value.

In an exemplary embodiment, FIG. 3C shows how to add a new relationship to the database. The user clicks on the source object 260, drags the mouse to the target object 270, and then clicks on the target object 270. A link 280 is drawn connecting the source object 260 to the target object 270. A relationship with the source object 260 as parent and the target object 270 as child is created and added to the view and to the database. The properties of the link can be edited in the properties pane 100.

Thus, the exemplary embodiments disclosed herein a graphical user interface, which allows an end-user to navigate and edit a hierarchy of objects and relationships. The user can add or remove parent and children nodes to or from the view by simply clicking on a given node, allowing the hierarchy to be examined to any desired level or detail. The user can drag-and-drop nodes from a palette to add new nodes to the database. Similarly, the user can add new relationships by establishing a link between two nodes in the view. The user can delete objects or relationships by clicking on them. The user can modify objects or relationships by clicking on them and changing their properties. The graphical user interface automatically scales and re-adjusts to accommodate the modified object relationships.

The capabilities of the embodiments descried herein can be implemented in software, firmware, hardware or some combination thereof.

As one example, one or more aspects of embodiments can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of embodiments of the claimed invention.

While exemplary embodiments have been described, it will be understood that those skilled in the art, both now and in the future, may make various improvements and enhancements which fall within the scope of the claims which follow. These claims should be construed to maintain the proper protection for the invention first described.

What is claimed is:

1. A method of displaying and editing a hierarchy of object relationships, the method comprising:
storing in a computer file a plurality of data objects;
identifying hierarchical relationships among the plurality of interrelated data objects, such that some objects maybe dynamically defined as parent objects, which may each have at least one dynamically defined child data object;
assembling a plurality of parent data objects in a repository;
assembling a plurality of child data objects in a repository;
providing a graphical user interface view pane for arranging one or more of the parent data objects and child data objects in a nodal tree-view, wherein any parent or child data object and any associated interrelated parent or child objects is added or removed form view and the data objects can be modified by a process wherein:
a palette is provided having a collection of object and relationship types, wherein new nodes and links can be added to the view pane via a drag-and-drop process; and
a properties pane is provided for displaying the properties of at least one of a selected object, node and link;
providing the user via the graphical user interface the ability to navigate down the hierarchy through parent data objects for displaying hierarchical relationships between at least one of the parent data objects and child data objects;
providing the user via the graphical user interface the ability to navigate the hierarchy through child data objects for displaying and editing hierarchical relationships between at least one of the parent data objects and the child data objects;
modifying existing object relationships by selecting, dragging, dropping and linking data objects shown in the view pane and selected from the palette; and
scaling and re-adjusting the display in accordance with the user-modified object relationships.

2. The method of claim 1 wherein selecting the palette provides a list of data objects of any available object-type and selecting a data object in the list adds the data object to the view.

3. The method of claim 2, wherein properties of a selected data object can be modified by selecting editable properties of the objects shown in the properties pane.

4. A system for displaying and editing a hierarchy of object relationships, the system comprising:
a computer file space containing a plurality of data objects;
a computer processor having instructions for identifying hierarchical relationships among the plurality of interrelated data objects, such that some objects may be dynamically defined as parent objects, which may have at least one dynamically defined child data object;
the computer processor having instructions for assembling the plurality of parent data objects and plurality of child data objects in a repository;
a computer display device for displaying a graphical user interface view pane for arranging one or more of the parent data objects and child data objects in to a nodal tree-view, wherein any parent or child data object and associated interrelated parent or child objects is added or removed from view and the data objects can be modified by a process, wherein:
a palette is provided having a collection of object and relationship types, wherein new nodes and links can be added to the view pane in a drag an drop process; and
a properties pane is provided for displaying the properties of at least one of a selected object, node and link; and
a computer input device operable by an end-user for allowing the end user to navigate a hierarchy of parent data objects for displaying hierarchical relationships between at least one of parent data objects and child data objects;
wherein the computer input device is operated by the end-user to:
navigate the hierarchy of child data objects for displaying and editing hierarchical relationships between at least one of parent data objects and child data objects; and
modify existing object relationships by selecting, dragging, dropping and linking objects shown in the view pane and selected from the palette;
wherein the graphical user interface scales and re-adjusts the display in accordance wit the end-user modified objects relationships.

5. The system of claim 4, wherein the object relationships are modifiable by selecting a source object, then using the computer input device to drag a link to a target object, and selecting the target object such that a relationship is created where the source object is the parent and the target object is the child.
